(19) United States
(12) Patent Application Publication
(10) Pub. No.: US 2024/0413622 A1
(43) Pub. Date: Dec. 12, 2024

(54) ELECTRICAL DEVICE FOR ELECTRIC VEHICLE CHARGER MANAGEMENT

(71) Applicant: POWER-Q, Montreal (CA)

(72) Inventors: Ezatullah H ALOKOZAI, Montreal (CA); Lord Richy DUPERRON, Montreal (CA); Abdallah MCHIRGUI, Montreal (CA)

(21) Appl. No.: 18/737,426

(22) Filed: Jun. 7, 2024

Related U.S. Application Data
(60) Provisional application No. 63/506,953, filed on Jun. 8, 2023.

(51) Int. Cl. H02G 3/08; G08C 19/00

(52) U.S. Cl. CPC H02G 3/081; G08C 19/00

(57) ABSTRACT

A device, system and method for selectively activating an electrical device. A delivered power reading through hot wires of a junction box is received. When a current power reading is below a dynamic threshold value compared to a total power capacity rating value of the junction box, an activation signal is provided enabling power delivery from the hot wires to a two-pole breaker connected thereto, the two-pole breaker connecting the electrical device.

### PRIORITY STATEMENT

This non-provisional patent application claims priority based upon the prior U.S provisional patent application entitled “ELECTRICAL DEVICE FOR ELECTRIC VEHICLE CHARGER MANAGEMENT”, application No. 63/506,953, filed on 2023 Jun. 8, in the name of POWER-Q, which is herein incorporated by reference in its entirety.

### TECHNICAL FIELD

The present invention relates to an electrical device and, more particularly, to an electrical device for electric vehicle charger management.

### BACKGROUND

Energy requirements from electric vehicle chargers put high demands on circuit that were not necessarily designed for such purposes.

The present invention provides at least a partial solution to this problem.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations herein relate to a method for selectively powering an electrical device. For example, the method may include receiving a delivered power reading through hot wires from a junction box. The method may also include determining that a current power reading is below a dynamic threshold value compared to a total power capacity rating value of the junction box. The method may furthermore include providing an activation signal enabling power delivery from the hot wires to a two-pole breaker connected thereto, the two-pole breaker connecting the electrical device. Other embodiments of this aspect include corresponding computer systems, apparatus, and computer programs recorded on one or more computer storage devices, each configured to perform the actions of the methods.

The described implementations may also include one or more of the following features. The method where receiving the delivered power reading may include measuring the delivered power through hot wires using one or more amperage meter. The method where providing the activation signal may include activating a relay that connects the two-pole breaker with the electric device. The method may include, prior to providing the activation signal, computing a maximum available power value and addressing a message containing the computed maximum available power value to the electrical device, the maximum available power value being smaller than a rated power value for the electrical device. The method may include computing the dynamic threshold taking into account at least one of: the total power capacity rating value for the junction box; time data; date data; an identifier of the electronic device; power delivery data related to one or more co-located junction boxes; and instructions received from a central server. The method may include receiving the dynamic threshold value from a central server. The method may include, prior to providing the activation signal, sending a message to a central server requesting authorization to activate the electrical device, where providing the activation signal is performed upon receipt of an authorization from the central server. Implementations of the described techniques may include hardware, a method or process, or a computer tangible medium.

Some implementations herein relate to an electric circuit manager that may include a housing configured to fit within a junction box, the junction box providing interconnecting hot wires and a two-pole circuit breaker connected thereto, a total power capacity rating value being attributed to the junction box. The electric circuit manager may also include a control module configured to: provide an activation signal when a measured delivered power is below a dynamic threshold value compared to the total power capacity rating value, the activation signal enabling power delivery from the hot wires to the two-pole breaker. Other embodiments of this aspect include corresponding computer systems, apparatus, and computer programs recorded on one or more computer storage devices, each configured to perform the actions of the methods.

The described implementations may also include one or more of the following features. The electric circuit manager may include a network interface configured to: send a message to a central server requesting authorization to activate the electrical device, where providing the activation signal is performed upon receipt of an authorization from the central server. The electric circuit manager may include a network interface configured to receive the dynamic threshold value from a central server. The electric circuit manager where the control module is further configured to measure the delivered power through the hot wires using one or more amperage meter. Implementations of the described techniques may include hardware, a method or process, or a computer tangible medium.

Some implementations herein relate to a system that may include a junction box having a total power capacity rating value, the junction box having: interconnecting hot wires; a two-pole breaker; and an electric circuit manager. The system electric circuit manager may have a housing configured to fit within the junction box and one or more processors configured to: receive a delivered power reading through the hot wires; determine that a current power reading is below a dynamic threshold value compared to the total power capacity rating value; and provide an activation signal enabling power delivery from the hot wires to a two-pole breaker connected thereto, the two-pole breaker connecting the electrical device. Other embodiments of this aspect include corresponding computer systems, apparatus, and computer programs recorded on one or more computer storage devices, each configured to perform the actions of the methods.

The described implementations may also include one or more of the following features. The system may include one or more amperage meter configured to measure the delivered power through hot wires using. The system may include a relay that connects the two-pole breaker with the electric device, where providing the activation signal further may include activating the relay. The system where the one or more processors are further configured to, prior to providing the activation signal, computing a maximum available power value and where the electrical circuit manager further may include a network interface configured to address a message containing the computed maximum available power value to the electrical device, the maximum available power value being smaller than a rated power value for the electrical device. The system where the one or more processors are further configured to compute the dynamic threshold taking into account at least one of: the total power capacity rating value for the junction box time data date data an identifier of the electronic device power delivery data related to one or more co-located junction boxes; and instructions received from a central server. The system where the electrical circuit manager may include a network interface configured to receive the dynamic threshold value from a central server. The system where the electrical circuit manager may include a network interface configured to, prior to providing the activation signal, send a message to a central server requesting authorization to activate the electrical device, where providing the activation signal is performed upon receipt of an authorization from the central server. Implementations of the described techniques may include hardware, a method or process, or a computer tangible medium.

### BRIEF DESCRIPTION OF THE DRAWINGS

Further features and exemplary advantages of the present invention will become apparent from the following detailed description, taken in conjunction with the appended drawings, in which:

FIG. 1 is a logical modular representation of an exemplary networked circuit manager deployed in a system in accordance with the teachings of the present invention;

FIG. 2 is logical modular representation of an exemplary junction box deployed in a system in accordance with the teachings of the present invention;

FIG. 3 is a flow chart of an exemplary method in accordance with the teachings of the present invention; and

FIG. 4 is a photographic view of an exemplary junction box deployed in a system in accordance with the teachings of the present invention.

### DETAILED DESCRIPTION

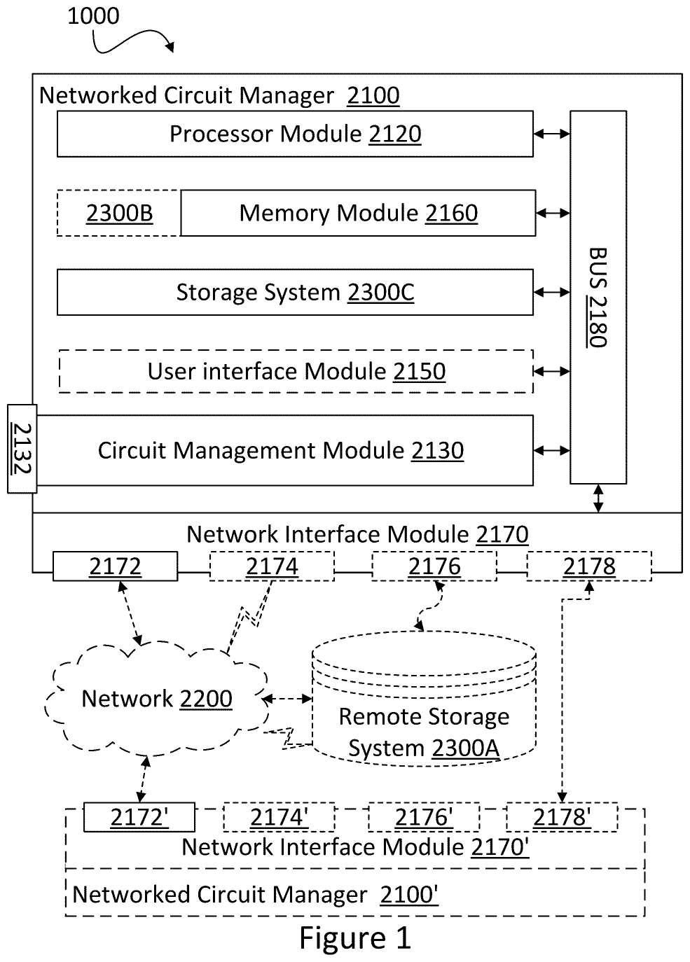

Reference is now made to the drawings in which FIG. 1 shows a logical modular representation of an exemplary system 1000 comprising a networked circuit manager 2100. The networked circuit manager 2100 comprises a memory module 2160, a processor module 2120, a circuit management module 2130 and a network interface module 2170. The networked circuit manager 2100 may also include a user interface module 2150.

The system 1000 may comprise a storage system 2300 for storing and accessing long-term (i.e., non-transitory) data and may further log data while the networked circuit manager 2100 is being used. FIG. 1 shows examples of the storage system 2300 as a distinct database system 2300A, a distinct module 2300C of the networked circuit manager 2100 or a sub-module 2300B of the memory module 2160 of the networked circuit manager 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the networked circuit manager 2100 by a standardized or proprietary interface or via the network interface module 2170.

The network interface module 2170 represents at least one physical interface that can be used to communicate with other network nodes (e.g., including other networked circuit managers). The network interface module 2170 may be made visible to the other modules of the networked circuit manager 2100 through one or more logical interfaces. The actual stacks of protocols used by the physical network interface(s) and/or logical network interface(s) 2172-2178 of the network interface module 2170 do not affect the teachings of the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.).

A bus 2180 is depicted as an example of means for exchanging data between the different modules of the networked circuit manager 2100. The teachings presented herein are not affected by the way the different modules exchange information. For instance, the memory module 2160 and the processor module 2120 could be connected by a parallel bus, but could also be connected by a serial connection or involve an intermediate module (not shown) without affecting the teachings of the present invention.

A circuit management module 2130 provides circuit management-related services to the networked circuit manager 2100, which will be described in more details herein below.

The variants of processor module 2120, memory module 2160 and network interface module 2170 usable in the context of the present invention will be readily apparent to persons skilled in the art. Likewise, even though explicit mentions of the circuit management module 2130, the memory module 2160, the user interface module 2150 and/or the processor module 2120 are not made throughout the description of the present examples, persons skilled in the art will readily recognize when such modules are used in conjunction with other modules of the networked circuit manager 2100 to perform routine as well as innovative elements presented herein.

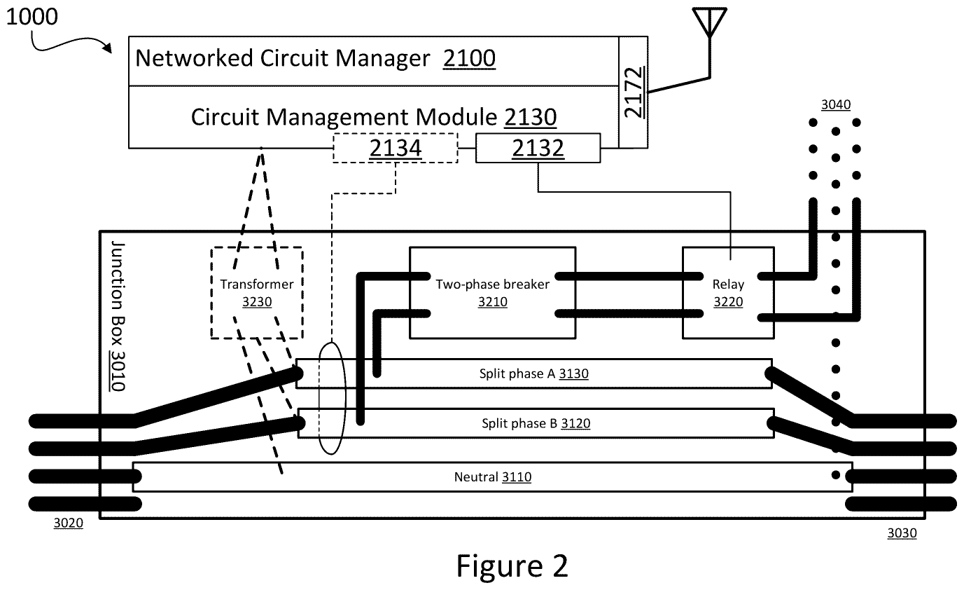

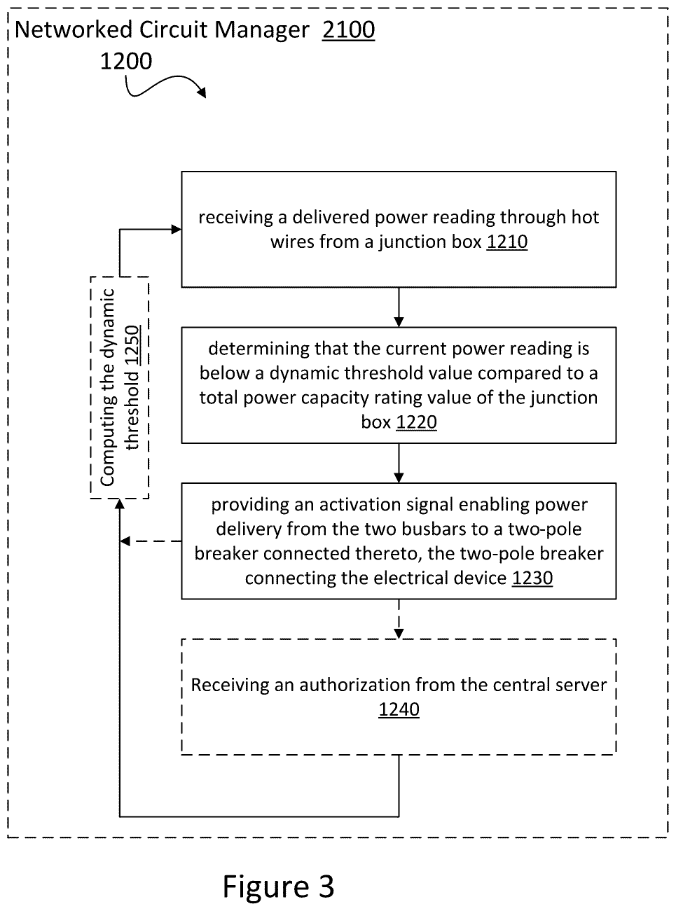

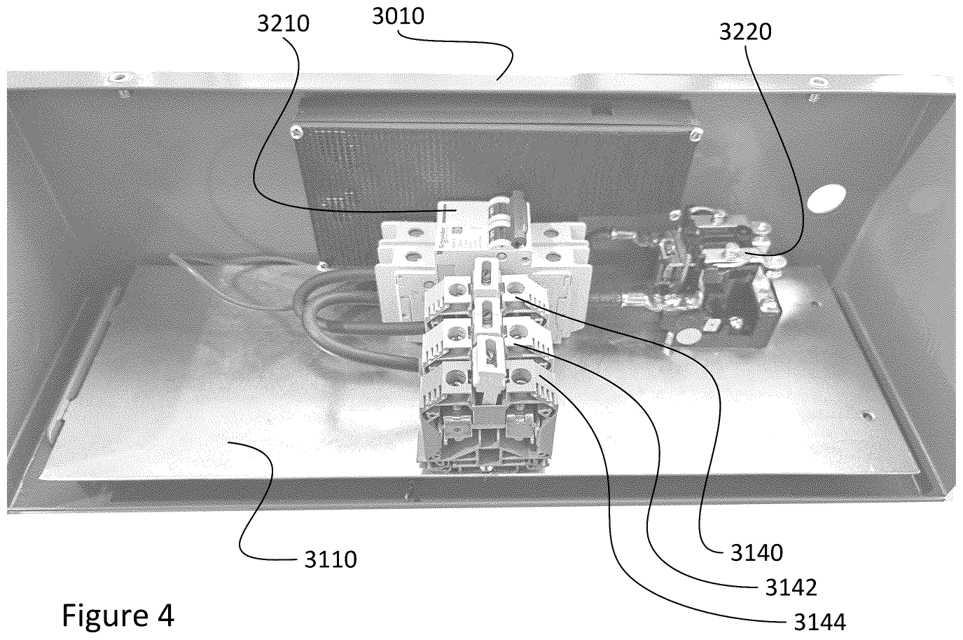

Reference is now concurrently made to FIGS. 1, 2, 3 and 4. FIG. 2 is a logical module representation further depicting an exemplary junction box 3010 (or entry box) in the system 1000. FIG. 3 is a flow chart of an exemplary method 1200. FIG. 4 present a photograph of one embodiment of the exemplary junction box 3010.

On FIG. 2, the junction box 3010 is shown with a cable 3020 entering therein and a cable 3030 exiting thereof. The junction box 3010 is therefor interconnecting the two cables 3020 and 3030. In selected implementations, the junction box 3010 is installed by sectioning a cable and inserting the junction box 3010 thereat.

In the depicted example, the junction box 3010 comprises three busbars: a neutral busbar 3110, a first hot busbar 3120 and a second hot busbar 3130. The cables 3020 and 3030 are depicted with a fourth neutral wire grounded to the junction box 3010. Depending on, for instance, the electrical code applicable to the location where the junction box 3010 is installed, there may be only three wires (not shown) where the neutral busbar is absent and/or grounded to the junction box 3010 (i.e., grounded neutral configuration). There may alternatively be three hot busbars (not shown) or hot wires instead of two. Skilled persons will readily understand that the wire-configuration (i.e., hot, neutral and/or ground) may therefore vary without affecting the teachings provided herein. Likewise, the busbars 3120 and 3130 are indicated as split-phase differentiated on FIG. 2 whereas other phase configurations could also be used (e.g., three-phase over three hot wires, two-phase instead of split phase, single phase over a single wire . . . ). A third cable 3040 is depicted exiting the junction box 3010. The cable 3040 connects an electrical device (e.g., an electric vehicle charger) thereto (not shown). In the depicted example, the cable 3040 comprises two hot wires and may further comprise a neutral and/or a ground wire (not shown). As can be understood from the above comment related to the wire-configuration of the junction box 3010, the cable 3040 may also provide different wire-configurations (e.g., three hot wires and a neutral). Furthermore, skilled persons will readily recognize that the use of busbars 3110, 3120, 3130 is meant to provide one example and that other equivalent solutions may completely or partially replace the busbars 3110, 3120, 3130 (e.g., as can be understood from FIG. 4, cables 3020, 3030 may be connected to interconnectors 3140, 3142, 3144).

The exemplary junction box 3010 also comprises a two-phase breaker (also referred to as two-pole breaker) 3210 and a relay 3220 that selectively connects the electrical device and the two-pole breaker 3210 to the two busbars 3120 and 3130. The networked circuit manager 2100 is depicted beside the junction box 3010. In selected embodiments, the networked circuit manager 2100 comprises a housing (not shown) that fits within the junction box 3010. Skilled persons will readily understand that the depiction of FIGS. 1 and 2 is logical and not drawn to scale and should be read as such. In some implementations, a transformer 3230 may be provided to provide DC power to the networked circuit manager 2100. Other powering methods could be used as skilled persons will readily acknowledge (e.g., charging current induced from power delivered though the junction box 3010).

The networked circuit manager 2100 shows the interface 2172 of the network interface module 2170 with an antenna for wireless communication. Alternatively or additionally, a physical cable port (e.g., RJ45) may also be provided. The circuit management module 2130 is depicted with an interface 2132 connecting to the relay 3220. In some embodiments, the circuit management module 2130 may further comprise a second interface 2134 connecting to one or more amperage readers on the busbars 3132 and 3130.

In one example, the networked circuit manager 2100 executes a method 1200 for selectively powering the electrical device. The method comprises receiving 1210 a delivered power reading through two hot busbars 3120 and 3130 from a junction box 3010. The method 1200 also comprises determining 1220 that a current power reading is below a dynamic threshold value compared to a total power capacity rating value of the junction box 3010 and providing 1230 an activation signal enabling power delivery from the two busbars 3120 and 3130 to a two-pole breaker 3210 connected thereto (may also be referred to as a two-phase breaker). As depicted, the two-pole breaker 3210 ultimately connects the electrical device to the junction box 3010.

Receiving 1210 the delivered power reading may further comprise measuring the delivered power through two hot busbars 3120 and 3130 using one or more amperage meter. Additionally or alternatively, providing 1230 the activation signal may further comprise activating a relay 3220 that interconnects the two-pole breaker 3210 and the electric device.

Prior to providing the activation signal, the networked circuit manager 2100 may further compute a maximum available power value and may further address a message containing the computed maximum available power value to the electrical device. The maximum available power value is smaller than a rated power value for the electrical device. For instance, the message may indicate that the electrical device (e.g., EV charger) can take a maximum of 20 A on a theoretical 32 A or 40 A circuit.

In some instances, the method further comprises computing 1250 the dynamic threshold value taking into account at least one of: the total power capacity rating value for the junction box; time data; date data; an identifier of the electronic device; power delivery data related to one or more co-located junction boxes (not shown); and instructions received from a central server (not shown). The dynamic threshold value computation 1250 may take into account a tolerance to a surge or an overload that is dependent on the extent and duration thereof (e.g., how many additional amps and for how long). The time data and/or date data may be used when electricity tariffs dynamically vary (e.g., predictably or dynamically) during a period (e.g., a day). The time data and/or date data may therefore be considered when computing the dynamic threshold value (e.g., coefficient read from lookup table and/or coefficient as a function of tariff vs time). The identifier of the electronic device may provide information about the characteristics, capacities and/or limitations of the electric device (e.g., rated EV charger capacity, known switch-on surge characteristics, etc.). The power delivery data from one or more co-located junction boxes may be useful when the junction box 3010 shares a common utility service connection or is otherwise affected by the other boxes (e.g., different utility service connections sharing a single tariff based on agglomerated power usage).

As such, skilled persons will understand that the dynamic threshold value may be computed 1250 from a power reading or may additional or alternatively be computed 1250 from one or more related values (e.g., amperage reading (or current intensity reading); amperage reading for a certain duration; voltage drop over a certain period of time; voltage variation over a certain period of time, etc.) For instance, the dynamic threshold value may be defined as a linear or non-linear function of one or more parameters. For instance, with A corresponding to an amperage reading and t to a time duration, dynamic threshold value=f(A, t). As another example, dynamic threshold value=f(A, t, h) with h providing time-of-day information. As yet another example, dynamic threshold value=f(A, t, T) with T providing a temperature reading, which may be received from another node (not shown) and/or taken at the junction box and/or at another location (e.g., inside or outside temperature). As yet another example, dynamic threshold value=f(ΔV, t, T) with ΔV corresponding to a voltage reading and/or a voltage reading variation over time.

The method 1200 may alternatively further comprise receiving the dynamic threshold value from a central server (not shown).

The method 1200 may further comprise, prior to providing 1230 the activation signal, sending a message to a central server requesting authorization to activate the electrical device and providing 1230 the activation signal may then be wait upon receipt 1240 of an authorization from the central server.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. An electric circuit manager comprising:
a housing configured to fit within a junction box, the junction box interconnecting hot wires and comprising a two-pole circuit breaker connected thereto, a total power capacity rating value being attributed to the junction box; and
a control module configured to:
provide an activation signal when a measured delivered power through the hot wires is below a dynamic threshold value compared to the total power capacity rating value, the activation signal enabling power delivery from the hot wires to the two-pole breaker.

2. The electric circuit manager of claim 1, further comprising a network interface configured to:
send a message to a central server requesting authorisation to activate the electrical device, wherein providing the activation signal is performed upon receipt of an authorization from the central server.

3. The electric circuit manager of claim 1, further comprising a network interface configured to receive the dynamic threshold value from a central server.

4. The electric circuit manager of claim 1, wherein the control module is further configured to measure the delivered power through the hot wires using one or more amperage meter.

5. A method for selectively powering an electrical device comprising:
receiving a delivered power reading through interconnecting hot wires from a junction box;
determining that a current power reading is below a dynamic threshold value compared to a total power capacity rating value of the junction box; and
providing an activation signal enabling power delivery from the hot wires to a two-pole breaker connected thereto, the two-pole breaker connecting the electrical device.

6. The method of claim 5, wherein receiving the delivered power reading further comprises measuring the delivered power through the hot wires using one or more amperage meter.

7. The method of claim 5 wherein providing the activation signal further comprises activating a relay that connects the two-pole breaker with the electric device.

8. The method of claim 5, further comprising, prior to providing the activation signal, computing a maximum available power value and addressing a message containing the computed maximum available power value to the electrical device, the maximum available power value being smaller than a rated power value for the electrical device.

9. The method of claim 5, further comprising computing the dynamic threshold taking into account at least one of:
the total power capacity rating value for the junction box;
time data;
date data;
an identifier of the electronic device;
power delivery data related to one or more co-located junction boxes; and
instructions received from a central server.

10. The method of claim 5, further comprising, receiving the dynamic threshold value from a central server.

11. The method of claim 5, further comprising:
prior to providing the activation signal, sending a message to a central server requesting authorisation to activate the electrical device, wherein providing the activation signal is performed upon receipt of an authorization from the central server.

12. A system for selectively powering an electrical comprising:
a junction box having a total power capacity rating value, the junction box comprising:
interconnecting hot wires;
a two-pole breaker;
an electric circuit manager comprising a housing configured to fit within a junction box and one or more processors configured to:
receive a delivered power reading through the hot wires;
determine that a current power reading is below a dynamic threshold value compared to the total power capacity rating value; and
provide an activation signal enabling power delivery from the hot wires to a two-pole breaker connected thereto, the two-pole breaker connecting the electrical device.

13. The system of claim 12, further comprising one or more amperage meter configured to measure the delivered power through hot wires using.

14. The system of claim 12, further comprising a relay that connects the two-pole breaker with the electric device, wherein providing the activation signal further comprises activating the relay.

15. The system of claim 12, wherein the one or more processors are further configured to, prior to providing the activation signal, computing a maximum available power value and wherein the electrical circuit manager further comprises a network interface configured to address a message containing the computed maximum available power value to the electrical device, the maximum available power value being smaller than a rated power value for the electrical device.

16. The system of claim 12, wherein the one or more processors are further configured to compute the dynamic threshold taking into account at least one of:
the total power capacity rating value for the junction box;
time data;
date data;
an identifier of the electronic device;
power delivery data related to one or more co-located junction boxes; and
instructions received from a central server.

17. The system of claim 12, wherein the electrical circuit manager further comprises a network interface configured to receive the dynamic threshold value from a central server.

18. The system of claim 12, wherein the electrical circuit manager further comprises a network interface configured to, prior to providing the activation signal, send a message to a central server requesting authorisation to activate the electrical device, wherein providing the activation signal is performed upon receipt of an authorization from the central server.
